(19) United States
(12) Patent Application Publication
(10) Pub. No.: US 2013/0043396 A1
(43) Pub. Date: Feb. 21, 2013

(54) MOTION DETECTOR WITH HYBRID LENS

(71) Applicant: Pinhas SHPATER, Haifa (IL)

(72) Inventor: Pinhas SHPATER, Haifa (IL)

(73) Assignee: NINVE JR. INC., Nassau (BS)

(21) Appl. No.: 13/570,164

(22) Filed: Aug. 8, 2012

Related U.S. Application Data
(60) Provisional application No. 61/525,716, filed on Aug. 19, 2011.

(51) Int. Cl. G02B 3/08; G01J 5/08

(52) U.S. Cl. 250/353; 359/742

(57) ABSTRACT

A lens assembly for a passive infrared motion detector has one or more rows of far field Fresnel lenses arranged on a substantially cylindrical sheet and operative to collect light onto a sensor location. A plurality of rows of mid/near field Fresnel lenses are arranged on a basically spherical sheet, and the mid/near field lenses are operative to collect light onto the sensor location. An infrared motion detector also has an infrared sensor with a lens assembly having a plurality of lenses on a spherical surface collecting light from a corresponding number of zones onto said sensor, and a reflector mounted in the detector directs light collected by at least one of the lenses onto the sensor for providing one or more creep zones.

### TECHNICAL FIELD

This patent application relates to passive infrared motion detection devices using Fresnel lens arrays.

### BACKGROUND

Motion detectors are used in a variety of applications, but most commonly in security systems and in lighting control system. Passive infrared motion detectors are one type of motion detector that uses optics, namely lenses and/or reflectors, to collect infrared light emitted by people and to direct that light onto a pyroelectric sensor that converts heat to an electric signal. That signal is processed to detect motion.

Many passive infrared motion detectors use Fresnel lenses printed or molded in thin plastic sheets to focus light from an area onto the sensor. The amount of light reaching the sensor depends on the optical properties of the Fresnel lens, and is in direct relation to the size of the lens area. The lens material is not 100% transparent and its thickness affects the signal level transmission. When the lens area is perpendicular to the direction of the area being covered, the losses due to lens thickness are the least because the light passes through minimal lens material. Additional improvement on collecting the received optical signal can be further obtained when the sensor is perpendicular to the direction of the light coming from a Fresnel lens.

Since the need to efficiently collect light is more important for areas farther from the detector is greatest, the common Fresnel lenses and geometry of the sensor and lenses are designed such that efficiency of collection is optimized for the far areas or zones, at the expense of efficiency for the closer areas. Most typically, a sheet having a large number of Fresnel lenses is curved to be essentially cylindrical. The images collected by the lenses are focused onto the focal plane which is virtually located on a vertical axis located at the cylinder center, Thus, to obtain maximum efficiency from the far looking zones, the sensor is positioned normally on the vertical axis focal plane, and positioned at the same height as the row of Fresnel lenses that collect light from farther areas.

While the lenses collecting light from closer areas are located lower than the sensor, the closer the area, the lower the row height is, thus having lower IR light transmission efficiency due to increased attenuation caused by longer light path through the lens material. This lower efficiency is compensated by the fact that a stronger signal is obtained from a closer object, and then also if needed, by increased lens collecting area.

It is known to arrange Fresnel lenses on a support structure that is not planar or cylindrical. In some cases, the support structure is in an array, as in U.S. Pat. No. 5,187,360, or a plurality of curved sheets, as in U.S. Pat. No. 5,221,919. In some cases, the lens assembly is spherical, as in U.S. Pat. No. 7,635,846. When the lenses are arranged on a spherical sheet and the detector is mounted at a position on a wall, the lenses of the detector are perpendicular to the direction of the area being covered.

The advantage of a spherical lens arrangement is that it allows more than only the far zones' collected energy to penetrate the lens material perpendicularly, thus obtaining an overall increased efficiency. However, it can be used only for small size lenslets, as each lenslet area is curved and only a small portion of each lenslet maintains a “flat and perpendicular” characteristic. Therefore the far looking lens area size is limited and practically, reduces the efficiency of large area lenslets, such as the row of the far looking beams, where larger area is needed, but there is insufficient perpendicular added area for the needed received light energy. For the same reason, practically the spherical “above the rim” is practically of no use, and such designs typically use a “half spherical lens shape design.

### SUMMARY

It has been discovered that a combination of a cylindrical lens assembly geometry and a spherical lens geometry can overcome problems found in the prior art Fresnel lens assembly designs.

One advantage of combining cylindrical and spherical lens assemblies is that the lens efficiency can be increased, and with this higher efficiency, a smaller lens assembly can be used to provide a given amount of light collection on a sensor. The size of a lens assembly often large part of a detector size, and it is advantageous to be able to reduce the size of a detector without compromising detection effectiveness.

Another advantage of combining cylindrical and spherical lens assemblies is that both far field sensitivity and near field sensitivity can be maintained without compromising one for the other.

Another advantage of combining cylindrical and spherical lens assemblies is that lens losses are minimized substantially for all of the Fresnel lenses of the lens assembly.

Another advantage of combining cylindrical and spherical lens assemblies is that the lens assembly structure can benefit from stronger resistance to damage from handling or pressure on the lens assembly than a conventional cylindrical lens assembly.

Another advantage of combining cylindrical and spherical lens assemblies is that creep zone coverage can be provided without compromising sensitivity or effectiveness for the far field.

In some embodiments, there is provided a lens assembly for a passive infrared motion detector having one or more rows of far field Fresnel lenses arranged on a substantially cylindrical sheet, the far field lenses being operative to collect light onto a sensor location, and a plurality of rows of mid/near field Fresnel lenses arranged on a substantially spherical sheet, the mid/near field lenses being operative to collect light onto the sensor location.

In some embodiments, the cylindrical sheet and the spherical sheet are two portions of a single molded sheet. In other embodiments, the cylindrical sheet and the spherical sheet are separate sheets, and the assembly has a middle support member for holding the cylindrical sheet and the spherical sheet with respect to one another.

In some embodiments, the cylindrical sheet comprises at least two rows of far field Fresnel lenses. In some embodiments, the spherical sheet comprises three rows of Fresnel lenses.

In some embodiments, the far field lenses and the mid/near field lenses are configured to collect light from a beam direction that is substantially perpendicular to the lenses.

In some embodiments, the Fresnel lenses each have an aperture sized to collect substantially a same amount of light from a same light emitting object from respective beam directions for an intended mounting position.

In some embodiments, there is provided an infrared motion detector comprising an infrared sensor and a lens assembly as defined above that is mounted in a predetermined position with respect to the sensor.

In some embodiments, the detector includes a reflector mounted above the sensor for reflecting light from at least one of the mid/near field Fresnel lenses onto the sensor to provide one or more creep beams. The creep beams may be distinct from and closer than beams of the near field lenses that reach the sensor without substantive reflection by said reflector.

In some embodiments, the sensor is located at a vertical position corresponding to the rows of far field Fresnel lenses. The rows of far field lenses may be two in number, and the sensor may be located between the rows.

In some embodiments, the detector has a housing, and the lens arrangement comprises a single molded body having tabs connected to the housing for supporting the body on the detector.

In some embodiments, the rows of far field lenses are one or two in number, the cylindrical sheet of the lens assembly is resistant to deformation resulting from external pressure due to handling of the detector.

### BRIEF DESCRIPTION OF THE DRAWINGS

The invention will be better understood by way of the following detailed description of embodiments of the invention with reference to the appended drawings, in which:

FIG. 1A illustrates schematically a horizontal cross-section of a pair of prior art Fresnel lenses on a common cylindrically bent sheet focussing light onto a sensor;

FIG. 1B illustrates schematically a vertical cross-section of a prior art Fresnel lens sheet, also bent to be cylindrical, having four rows of lenses focussing light onto a sensor;

FIG. 2A is a front view of a passive infrared motion detector having a lens assembly showing a single body having an array of Fresnel lenses, the body having a lower spherical configuration and an upper cylindrical configuration.

FIG. 2B is an illustration of a cylindrical geometry with an axial plane.

FIG. 2C is a side view of the motion detector of FIG. 2A showing far beams reaching the cylindrical portion of the lens assembly.

FIG. 2D is an illustration of a spherical geometry with an axial plane.

FIG. 2E is a side view of the motion detector of FIG. 2A showing mid/near field beams reaching the spherical portion of the lens assembly.

FIG. 2F is a side cross-sectional view of a passive infrared motion detector having a lens assembly showing a single body having an array of Fresnel lenses, the body having a lower spherical configuration and an upper cylindrical configuration.

FIG. 2G is a side cross-sectional view of a passive infrared motion detector having a lens assembly with two lens bodies, one spherical and one cylindrical.

FIG. 3A is a side cross-sectional view of the embodiment of FIG. 1 in which a reflector has been added to provide an image of the sensor at a position that collects infrared light through lower Fresnel lenses from a “creep” zone below the detector.

FIG. 3B is a partial front elevation view of the embodiment of FIG. 3a showing the shape of the reflector.

FIG. 4A is a front view of a lens according to one embodiment having a plurality of rows of lenslets, two on a cylindrical portion and four on a spherical portion of a single body;

FIG. 4B is a horizontal cross-section of the lens body of FIG. 4A;

FIG. 4C illustrates a “beam” arrangement for a wall-mounted passive infrared detector showing close or near-field “beams” and far-field “beams”.

### DETAILED DESCRIPTION

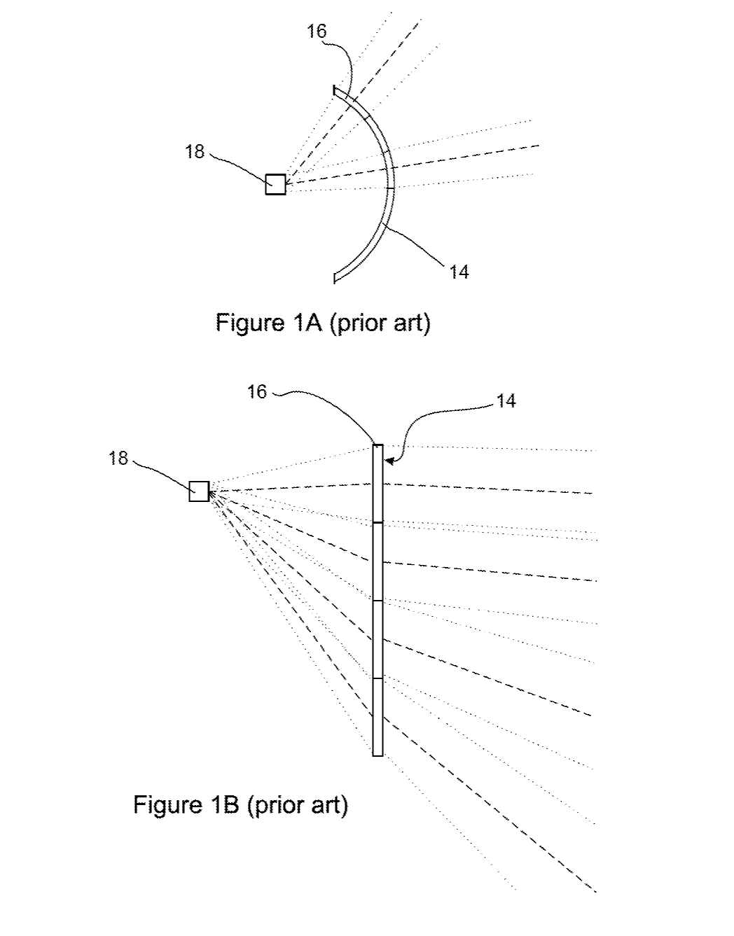

As illustrated in FIG. 1A, a conventional lens body 14 is a cylindrical body 14 having Fresnel lenses or lenslets 16. The beam directions are essentially perpendicular to the lens body 14 and the sensor 18 is arranged essentially at the center of the cylinder. Although the light passes through roughly the same thickness of lens material for side beams as for center beams, the light reaching the sensor 18 from the side beams is received at an angle and may be less efficiently detected.

As shown in FIG. 1B, a conventional lens body 14 is often configured to direct light from far beams almost normally onto the sensor, while for closer beams, the light is focussed onto the sensor 18 using lower lenses 16 that are below the sensor 18, and thus the light reaches the sensor at an oblique angle. The lower lenses 16 are however less efficient than the upper lenses 16 because of the angle they make with respect to their beams and the angle they make with respect to the sensor 18, along with the greater lens thickness seen by more oblique rays passing through the lens material that can cause greater absorption of light.

In some conventional detectors, the lens body 14 may be tilted with respect to a vertical direction to face downward.

This reduction in efficiency is not seen conventionally as a problem since the intensity of light reaching the lens body 14 from near zones is much greater than for far zones. However, the size of the lens body 14 has to be increased to provide the near beams and the ability to efficiently collect light from the near field is compromised.

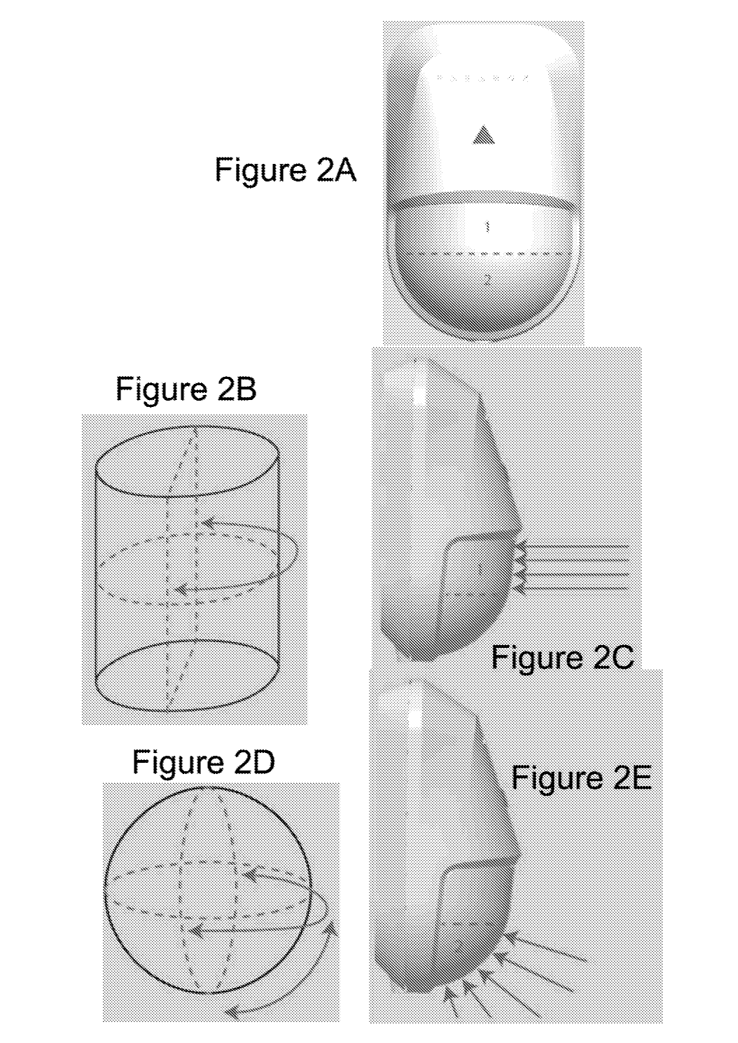

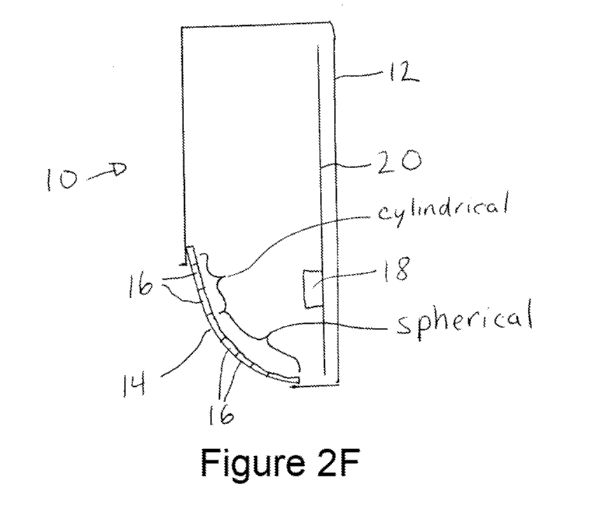

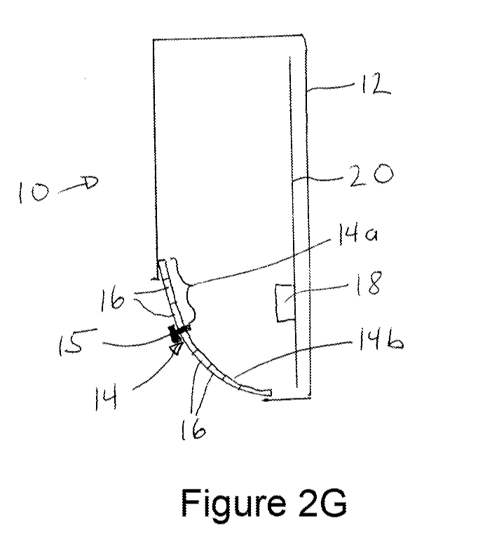

In the embodiment of FIG. 2A, there is shown a wall-mounted infrared motion detector having a lens assembly showing an upper cylindrical portion 1 and a lower spherical portion 2. As illustrated in FIG. 2B, the cylindrical geometry has a vertical axis plane, and the detector shown in FIG. 2C shows upper lens assembly portion 1 with a cylindrical geometry for focussing far field beams. As illustrated in FIG. 2D, the spherical geometry has a vertical axis plane, and the detector shown in FIG. 2E has a lower lens assembly portion 2 with a spherical geometry for focussing mid/near field beams.

In the embodiment of FIG. 2F, the detector unit 10 has a housing 12, lens assembly 14 that provides a plurality of Fresnel lenses 16 molded or printed thereon, a sensor 18 and a printed circuit board 20 having signal processing and communications circuitry.

The lenses 16 have a larger aperture in the cylindrical portion for collecting the greatest amount of light from the far field since the infrared light being collected from the far field is less intense. The apertures of the lenses 16 can be arranged to provide approximately the same signal strength at the detector 18 in response to the same object moving through the field of view. Thus the apertures of lenses 16 collecting light from closer range can be smaller. Alternatively, one may prefer having the lenses only partially compensate for the distance of the objects being detected, wherein signals from far objects are less than signals from near objects.

As illustrated, the cross-section of the lenses 16 are larger for the upper lenses associated with the far field than for the lower lenses 16 associated with the near field.

The design of the lens assembly 14 is different from a conventional spherical lens assembly design in which a top row of lenses provides far field beams. In FIGS. 2E and 2F, not only is the spherical portion 2 made to stop short of a full quarter sphere, but the sensor position is well above the rim of the spherical portion, and the lenses 16 are designed accordingly to direct their light a higher than in the case of a conventional spherical lens assembly.

The general shape of the lens body or assembly 14 is to be roughly perpendicular to the direction of the “beam”, namely the direction from which light is focussed by a Fresnel lens 16 onto the detector. In the embodiment of FIG. 2A, the lens body 14 has a cylindrical upper portion and a spherical lower portion, and the body 14 is a single piece of plastic material. It will be appreciated that these shapes are convenient approximations, and that other shapes can be used to efficiently collect light involving transmission through the lenses 16 and absorption by the detector 18, where the angles the latter make with respect to the light affect efficiency.

Molded or printed Fresnel lenses are known in the art, as are the materials used to make them, and need not be described in detail herein to understand how to make the embodiments described. Generally, thinner lenses absorb less infrared light, so lenses are made as thin as possible, limited by the required structural strength.

Forming the lens assembly 14 as a single part, as in FIG. 2A, has two advantages, namely there is a single part to be mounted, and the strength imparted by the spherical geometry reinforces the cylindrical portion of the lens assembly.

It will also be appreciated that the spherical lens of FIG. 2A brings the near field lenses closer to sensor 18, and reduces the vertical height of the lens assembly, in comparison to the prior art lens assembly of FIG. 1B.

In the embodiment of FIG. 2B, the motion detector has a first lens body 14a that is cylindrical, and a second lens body 14b that is spherical. A middle support member 15 is provided to support the bottom of body 14a, as well as the top of body 14b.

Dividing the lens body into two geometrical sections can have the advantage that body 14a can be made as a flat strip that is held in housing 12 in a curved manner to take the roughly cylindrical shape. The more complex spherically shaped body 14b can thus be made smaller. The body 14a can also be made taller or shorter depending on the particular needs to collect more or less light from the far field without need to change the design of the roughly spherical mid or near field body 14b.

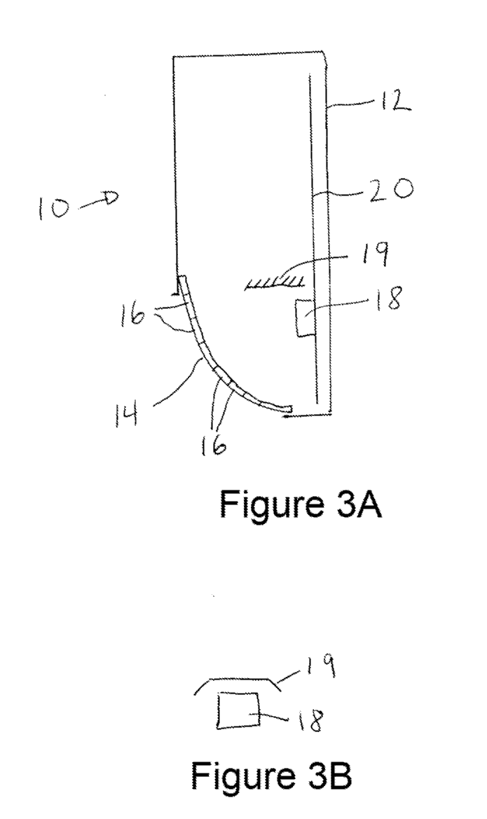

The embodiment of FIG. 3A is similar to the embodiment of FIG. 2A and has a reflector 19 added to redirect light collected from near field lenses onto the detector 18. The reflector 19 is placed above the light path of the top beam and preferably is tilted down by about 20 degrees from horizontal to reflect light towards the sensor 18. In the front elevation view of the detector 18 and reflector 19, shown in FIG. 3B, it can be seen that the reflector can have side wings to redirect light that is shifted to a side of the detector onto the detector 18. It will be appreciated that while the near field lenses 16 have their focal plane set to collect and direct light onto the detector 18, the reflector 19 provides an “image” (or multiple images) of the detector 18 that allows the near field lenses to direct light onto the detector from different viewing angles of the same lenslet, as well as detecting objects from a very close range, called the “creep zone”, more efficiently. This is achieved by the fact the light is directed to an image of the detector through the reflector that is farther than the actual detector, so the wings of the reflector 19 can help refocus light onto the detector 18.

The reflector 19 can also be arranged to improve detection by reflecting onto the detector 18 light that was incident on the detector at a low angle and thus was reflected instead of absorbed. This practically increases the down looking beams collecting area and therefore increases their width and signal strength.

It will be appreciated that reflector 19 can be shaped to improve light collection from the zone to be by the primary optics onto the sensor 18.

While the embodiment of FIGS. 3A and 3B show that Fresnel lenses whose beams are reflected by the reflector 19 are on a spherical lens assembly, the reflector can also be used to provide an enhancement of coverage with a non-spherical lens assembly, such as a cylindrical lens assembly, individual flat Fresnel lenses, or other suitable infrared optics.

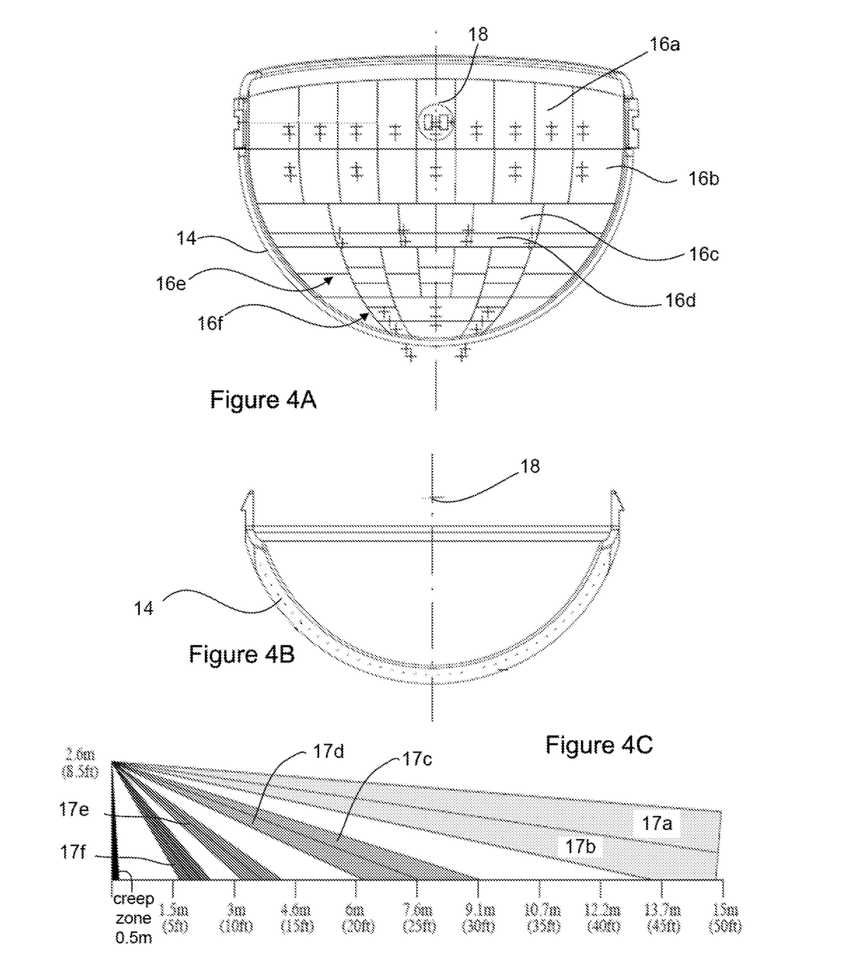

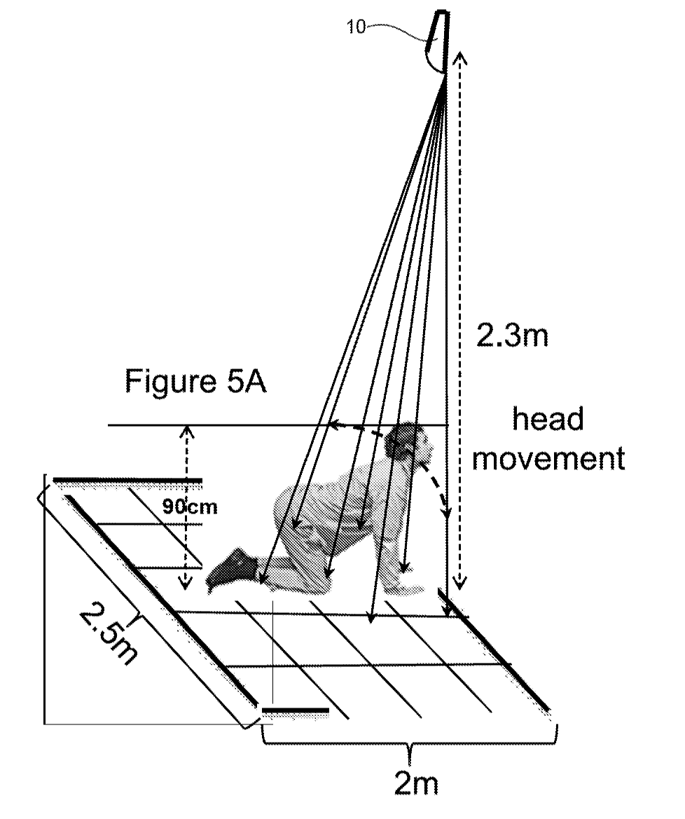

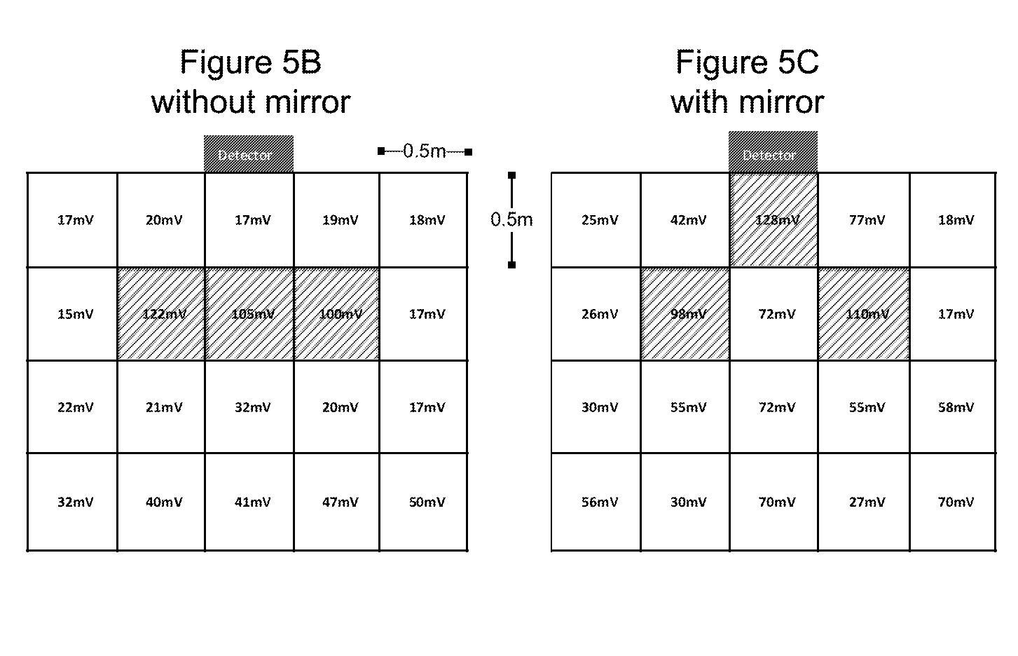

FIG. 4A shows a front elevation view of a single body lens array 14 having rows of Fresnel lenses 16a through 16d. The first two rows, 16a and 16b, are arranged on the cylindrical portion to focus light collected from far field beams, 17a and 17b respectively (see FIG. 4C), onto sensor 18. The cylindrical shape is shown in FIG. 4B with the sensor 18 approximately at the axis of the cylinder. The lens body 14 has tabs with hooks to snap onto the detector housing 12.

When the lens body 14 is mounted on the housing 10, the top cylindrical rim can be made sufficiently reinforced to withstand local external pressure. In a conventional lens body as shown in FIG. 1A, the middle of the cylindrical lens is vulnerable to external pressure, namely a knock in the middle that arises during handling of the detector during installation can dent the lens. In the embodiments described above, the cylindrical lens portion is not very high, and thus is not vulnerable to denting as the prior are cylindrical lens of FIGS. 1A and 1B would be. Furthermore, the spherical lower part of the lens of FIGS. 2A and 3A provides high resistance to external pressure.

FIG. 4C is a schematic illustration of the “beams” 17a through 17d provided by Fresnel lenses 16a through 16d. The term “beam” is used in the art to refer to the volume in space from which the Fresnel lens collects light and directs it onto the detector, even if the term normally connotes transmission. The number and beam direction of Fresnel lenses in an infrared motion detector to detect motion in an area is well known in the art, and need not be described in detail herein.

As shown, the lenses 16a and 16b collect light from the far field, about 13.7 m to 15 m. The detector 10 is often mounted about 2.6 m above floor level. It will be appreciated by those skilled in the art that the beam distances and arrangement is a matter of design choice for the detector, and that a variety of beam arrangements may be suitable. It will be noted that some rows of beams are arranged to be close to each other to form a zig-zag of upper and lower beams.

In some embodiments, the arrangement of beams 17 can be used to help discriminate between people and pets, as for example is described in commonly-assigned U.S. Pat. No. 6,215,399. When beams are arranged in an alternating height level, it is possible to discriminate between pets and people by the different signal patterns produced by pets and people. This arrangement of lenses 16 can be provided on the cylindrical portion of the lens assembly 14 and on the spherical portion for at least the mid field beams. The lenses 16a to 16f of FIG. 4A provide the corresponding beams 17a to 17f shown in FIG. 4C.

The intensity of infrared light reaching the detector unit 10 beyond 10 m away is quite weak, so rows of lenses 16a and 16b are the largest to collect more light. The lenses 16a and 16b are also substantially perpendicular to their beam directions, and this means that the rays pass through the least thickness of lens material. These lenses are arranged on the cylindrical portion of the lens arrangement 14. The uppermost lens 16c of the spherical portion of the body 14 has an aperture almost as large as the lenses 16a and 16b, and covers an area approximately within 7.6 m to 9 m from the unit 10. The next row of lenses 16d in the arrangement illustrated in FIGS. 4A and 4C have a smaller aperture and cover an area within about 6 m to 7.6 m from the unit 10. The next rows of lenses 16e cover the near field, namely within about 3 m to 4 m. The last rows of lenses 16f cover the nearest field, between 1.5 m and 2 m. The near field lenses 16c to 16f can be arranged into a variety of rows from 2 to 5 or more rows.

Since an area of 1 m immediately below the unit 10 would allow an intruder to escape detection by “creeping” against the wall to which the unit is mounted, the creep beam is provided to cover this area. The creep beam performance can be further improved by using a reflector as in the embodiment of FIGS. 3A and 3B, or separate lenses can be used. It will be understood that when a lens is used without a reflector, a compromise is struck between the beam-lens angle and the post-lens beam-sensor angle, bearing in mind that the lens-related losses are higher for the larger beam-lens angles and the beam-sensor angle also reduces sensitivity.

As illustrated in FIG. 5A, a test of the effect of the reflector 19 was performed by moving at a height of about 90 cm a person's head in the area immediately below the detector 10, and recording peak signal voltage at the center of squares as illustrated every 50 cm. It will be appreciated that other lenses 16 of the lens assembly 14 provide beams outside of this small area near the detector 10.

As shown in FIG. 5B, without the reflector 19, the closest central beam as designed for the lens assembly was 150 cm wide and 50 cm deep, starting at 50 cm from the wall position of the detector 10, and includes 3 squares in a line (hatched in FIG. 5B). These parameters depend on the choice of lens assembly design. The area between the wall and 50 cm from the wall provides little chance of detecting a person crawling.

However, the insertion of reflector 19 (in this case a metallic front surface mirror) as illustrated in FIGS. 3A and 3B, had the effect of changing the shape and sensitivity of the zones, as shown in FIG. 5C. Sensitivity with the reflector became greater in the area immediately below the detector than in any other area, and the beams have a V-shape formation for an effective creep zone coverage.

The peak signal strength measured without a reflector in the middle of the 50 cm by 50 cm squares as shown in FIG. 5B was:

| | | | | |
|---|---|---|---|---|
| 17 mV | 20 mV | 17 mV | 19 mV | 18 mV |
| 15 mV | 122 mV | 105 mV | 100 mV | 17 mV |
| 22 mV | 21 mV | 32 mV | 20 mV | 17 mV |
| 32 mV | 40 mV | 41 mV | 47 mV | 50 mV |

The detection threshold was set to about 85 mV, and the areas hatched are part of the detection zone. When the reflector 19 was used with the same lens assembly and the same detector position, the peak signal strength was measured in the same way again, as shown in FIG. 5C as follows:

| | | | | |
|---|---|---|---|---|
| 25 mV | 42 mV | 128 mV | 77 mV | 18 mV |
| 26 mV | 98 mV | 72 mV | 110 mV | 17 mV |
| 30 mV | 55 mV | 72 mV | 55 mV | 58 mV |
| 56 mV | 30 mV | 70 mV | 27 mV | 70 mV |

The beam now effectively covers the creep zone with good sensitivity for a person crawling below the detector against its wall.

It will be appreciated that the amount of light collected and directed onto the sensor from a given light emitting object can be tailored to be roughly the same for all beams by adjusting the size of the lenses 16 as a function of the range of the beam.

While the Fresnel lenses are described as being in rows, it will be understood that any suitable arrangement of the lenses on the body 14 can be used, and that a row need not necessarily have all lenses 16 of a row at the same horizontal position. On a spherical body, the lenses near the pole at the bottom are much smaller and can be arranged in any suitable pattern, without necessarily have a row arrangement.

While the lens arrangement 14 is described in the above embodiments as one or more curved bodies, it will be appreciated that a facetted construction having a polyhedron or geodesic framework with planar or curved sheets of one or more Fresnel lenses 16 to provide the required geometry can be substituted for a continuous body construction.

1. A lens assembly for a passive infrared motion detector, the assembly comprising:
one or more rows of far field Fresnel lenses arranged on a substantially cylindrical sheet, said far field lenses operative to collect light onto a sensor location; and
a plurality of rows of mid/near field Fresnel lenses arranged on a substantially spherical sheet, said mid/near field lenses being operative to collect light onto said sensor location.

2. A lens assembly as defined in claim 1, wherein said cylindrical sheet and said spherical sheet are two parts of a single molded sheet.

3. A lens assembly as defined in claim 1, wherein said cylindrical sheet and said spherical sheet are separate sheets, further comprising a middle support member for holding said cylindrical sheet and said spherical sheet with respect to one another.

4. A lens assembly as defined in claim 1, wherein said cylindrical sheet comprises at least two rows of far field Fresnel lenses.

5. A lens assembly as defined in claim 1, wherein said far field lenses and said mid/near field lenses are configured to collect light from a beam direction that is substantially perpendicular to said lenses.

6. A lens assembly as defined in claim 1, wherein said lenses each have an aperture sized to collect substantially a same amount of light from a same light emitting object from respective beam directions for an intended mounting position.

7. A lens assembly as defined in claim 1, wherein said spherical sheet comprises three rows of said lenses.

8. A lens assembly as defined in claim 1, wherein said spherical sheet comprises two rows of said lenses.

9. A lens assembly as defined in claim 1, wherein said spherical sheet comprises four rows of said lenses.

10. A lens assembly as defined in claim 1, wherein said spherical sheet comprises five rows of said lenses.

11. A lens assembly as defined in claim 1, wherein at least some of said rows of Fresnel lenses are arranged in an alternating height of beam direction for pet discrimination.

12. An infrared motion detector comprising:
an infrared sensor; and
the lens assembly as defined in claim 1 mounted in a predetermined position with respect to said sensor.

13. A detector as defined in claim 12, further comprising a reflector mounted above said sensor for reflecting light from at least one of said mid/near field Fresnel lenses onto said sensor to provide one or more creep beams.

14. A detector as defined in claim 13, wherein said creep beams are distinct from and closer than beams of said near field lenses that reach said sensor without substantive reflection by said reflector.

15. A detector as defined in claim 12, wherein said sensor is located at a vertical position corresponding to said one or more rows of far field Fresnel lenses.

16. A detector as defined in claim 15, wherein said rows of far field lenses are two in number, and said sensor is located between said rows.

17. A detector as defined in claim 12, comprising a housing, wherein said lens arrangement comprises a single molded body having tabs connected to said housing for supporting said body on said detector.

18. A detector as defined in claim 12, wherein said rows of far field lenses are at least two in number, said cylindrical sheet being resistant to deformation resulting from external pressure due to handling of the detector.

19. An infrared motion detector comprising:
an infrared sensor;
a lens assembly having a plurality of lenses on a spherical surface collecting light from a corresponding number of zones onto said sensor;
a reflector mounted in said detector for directing light collected by at least one of said lenses onto said sensor for providing one or more creep zones.

20. The detector as defined in claim 19, wherein said lens assembly comprises:
one or more rows of far field Fresnel lenses arranged on a substantially cylindrical sheet, said far field lenses operative to collect light onto a sensor location; and
a plurality of rows of mid/near field Fresnel lenses arranged on a substantially spherical sheet, said mid/near field lenses being operative to collect light onto said sensor location.
